(19) United States
(12) Patent Application Publication
(10) Pub. No.: US 2016/0025553 A1
(43) Pub. Date: Jan. 28, 2016

(54) METHOD FOR WIRELESS SIGNAL TRANSMISSION AND SENSOR-CONTROLLED COMPONENT

(71) Applicant: Hella KGaA Hueck & Co., Lippstadt (DE)

(72) Inventors: Hauke Baumgartel, Delmenhorst (DE); Bastian Kanning, Bremen (DE)

(21) Appl. No.: 14/808,796

(22) Filed: Jul. 24, 2015

(30) Foreign Application Priority Data
Jul. 25, 2014 (DE) 10 2014 011 156.3

(51) Int. Cl. G01J 1/02; B60Q 1/04

(52) U.S. Cl. CPC G01J 1/02; B60Q 1/04; H04W 84/18

(57) ABSTRACT

A method for wireless signal transfer from a sensor to a sensor-controlled component is provided. The sensor records a measuring signal and utilises the energy recorded with the measuring signal for operating an associated transmission unit. The signal transmitted by the emission unit is determined by the amount of energy recorded with the measuring signal. This enables the sensor to be operated autonomously.

### BACKGROUND OF THE INVENTION

1. Field of the Invention

The invention relates to a method for wireless signal transmission from a sensor to a sensor-controlled component, wherein the sensor records a measuring signal.

Furthermore the invention relates to a sensor-controlled component with a sensor for detecting a physical variable for controlling the component and with a connection between the component and the sensor.

2. Brief Discussion of the Related Art

The sensor may be a light sensor for controlling the headlight system in a motor vehicle. These light sensors are connected via supply lines to an energy supply and via data lines to a corresponding sensor-controlled component, such as the headlight system of the motor vehicle. The location for fitting the sensor is thus not freely selectable, but has to be selected so as to permit a voltage supply and a data bus connection to be installed.

### SUMMARY OF THE INVENTION

The invention is based on the requirement, to propose a method and a sensor-controlled component of the kind mentioned in the beginning, which permit a free selection of the fitting location.

The solution to this requirement is a method with the characteristics of patent claim 1. With regard to the component the solution is a component with the characteristics of patent claim 6. Advantageous further developments of the invention are described in the sub-claims.

With a method for wireless signal transmission from a sensor to a sensor-controlled component, wherein the sensor records a measuring signal, provision is made according to the invention for the sensor to utilise the recorded measuring signal as an energy source for operating an associated transmission unit and for the signal emitted by the transmission unit to be determined by the recorded energy.

Using such a method permits a wireless and that cable-free installation of the sensor. To this end a light sensor in a motor vehicle, for example, may be installed in a random location. The sensor detects a physical variable, such as electromagnetic waves within a certain frequency-range, for example within the range of visible light or infrared light, and uses the energy recorded with a measuring signal as an energy source. Also acoustic signals or other signals may serve as a measuring signal and energy source. The received and measured signal is thus used simultaneously as an energy supply to an associated transmission unit, with which wireless signal transmission is effected from the sensor to the sensor-controlled component. This sensor may therefore be controlled by an autonomous power supply and wirelessly.

It is favourable if the sensor transforms the measured signal into an electrical output variable using an energy-self-sufficient conversion principle. The signal emitted by the transmission unit is determined by the amount of energy recorded. That means that the amount of energy recorded operates the transmission unit and emits a signal to the sensor-controlled component in dependence of the amount of energy.

In a preferred embodiment of the invention the energy recorded by the sensor with the measuring signal determines the signal strength of the emitted signal. Using the signal strength, the sensor-controlled component or a control device of this sensor-controlled component can then draw conclusions as to the physical conditions at the sensor such as the light conditions or the acoustic conditions and can then use this measured variable for controlling the sensor-controlled component. Alternatively the energy recorded by the measuring sensor determines the signal frequency of the emitted signal. Therefore, with a strong measuring signal, which also provides a high amount of energy, the sensor of the associated transmission unit can then provide a higher amount of energy. Thus the emitted measuring signal may, for example, be particularly strong or have a particularly high amplitude. In another embodiment the recorded amount of energy correlates with the emitted signal frequency. This means that a particularly high measuring signal leads to a high signal frequency of the emitted signal. In a particularly preferred design these possibilities may be combined, which e.g. means that for a high amount of energy recorded the emitted signal comprises both a high amplitude and a high signal frequency. “High” is understood here in contrast to “low” to be for a lower amplitude or frequency which would result for an energy supply caused by a weaker measuring signal.

In another preferred embodiment of the invention the sensor uses light as a measuring signal and as an energy source. The sensor in this case is a light sensor or a photovoltaic cell which detects solar radiation and at the same time uses this as an energy source for a transmission unit. The emitted signal is directly dependent on the irradiated amount of light and may be interpreted in this way by the receiver. Alternatively, the sensors used may be temperature, vibration, flow or pressure sensors.

In another preferred embodiment of the invention the transmission unit sends a watchdog signal to the sensor-controlled component. As soon as the recorded measuring signal such as the lighting is strong enough to supply the transmission unit such as a radio transmitter with power, this radio transmitter sends a watchdog signal to the sensor-controlled component. Such a watchdog signal is transmitted continually, as long as the signal strength is sufficiently high to supply the transmission unit with power. Based on the signal strength or the signal frequency or based on a mixture of both, conclusions are drawn in the sensor-controlled component, in particular the control device thereof, as to the physical conditions, in particular the light conditions at the sensor.

A further aspect of the invention consists in providing a sensor-controlled component with a sensor for detecting a physical variable for controlling the component and a connection between the component and the sensor, wherein according to the invention provision is made for the connection between the component and the sensor to be a wireless radio connection, for the sensor to comprise a transmission unit and for the transmission unit to be operated exclusively with energy recorded by the sensor, wherein the energy recorded by the sensor determines a signal emitted by the transmission unit. A sensor-controlled component of this kind is operated, in particular, according to the method described. There is no need for any cables between the sensor and the sensor-controlled component or its control device. The sensor can be fitted entirely without cables, and thus in a freely selectable location. The sensor comprises a wireless radio connection to the component and draws its energy from the recorded measuring signal and therefore does not require its own energy supply. The sensor is thus completely without physical connections.

The sensor and its associated transmission unit are provided and designed for the purpose of emitting a signal with a signal strength, which corresponds to the energy recorded by the sensor. Alternatively or additionally, the sensor and its associated transmission unit are provided and designed for the purpose of emitting a signal with a frequency, which corresponds to the energy recorded by the sensor. Using such a sensor and such a transmission unit, the above-described method can be performed in a particularly favourable manner.

The sensor is preferably a photovoltaic cell. The control with the aid of light, which simultaneously serves as energy source, is particularly favourable and offers many possible applications. Alternatively the sensor may be a temperature sensor, a vibration sensor, a flow sensor or a pressure sensor. In principle all sensors are feasible, in which the desired measuring variable can be used as an energy source. The sensor further preferably comprises an energy converter, a logic unit and a transmission unit. It is favourable if the energy converter comprises a capacitor resistance and a coil, with which the energy recorded by the sensor is conditioned. The transmission unit is then controlled with the aid of a connected logic, in particular an integrated circuit. Preferably the sensor is completely without feed lines. The component is preferably a headlight system or an air conditioning system which is controlled by the sensor. In particular, the components are of a kind, which are part of a motor vehicle. The invention can be used to particular advantage in vehicles, in particular motor vehicles, since here the energy supply and the wiring present a special problem and a special challenge.

A further aspect of the invention relates to the provision of the sensor for the above-described component. It is also feasible to retrofit such a sensor and to connect it to already existing components.

### BRIEF DESCRIPTION OF THE DRAWINGS

The invention will now be described in detail with reference to an embodiment shown in the drawing.

The single schematic FIGURE of the drawing shows a sensor according to the invention with the sensor-controlled component and the associated energy intake and signal transmission.

### DETAILED DESCRIPTION OF THE PREFERRED EMBODIMENTS

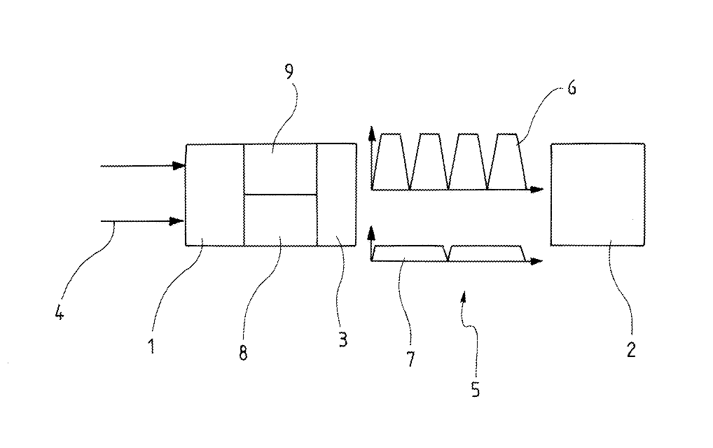

FIG. 1 shows a sensor 1. This records a measuring signal 4, which also serves as an energy supply and provides energy to the sensor 1. The sensor 1 is associated with a transmission unit 3. Furthermore a logic IC 8 and an energy converter 9 are arranged between the sensor 1 and the transmission unit 3. In particular the energy converter 9 comprises oscillating circuits consisting of a capacitor and a coil and preferably also resistances, with which the energy recorded by the sensor 1 is conditioned. The signal transmission coming from the transmission unit 3 is controlled by a connected logic IC 8. For a large amount of energy E, which arrives at the sensor 1 via the measuring signal 4, a signal is for example emitted according to the above description, wherein the amplitude 6 is relatively high and the frequency of the emitted signals is relatively high. For a relatively low amount of energy E, which is received by the sensor 1 with the measuring signal 4, the emitted signal rather corresponds to the embodiment shown below with a comparatively low amplitude 6 and comparatively high frequency 7. If the sensor emits no measuring signal at all, no signal 5 is emitted either. The signal 5 is received by the sensor-controlled component. This comprises, in particular, a receiver with an antenna and an evaluation unit, with which the component 2 is then controlled. The component 2 may, for example, be an air conditioning system. The components are, in particular, elements within a motor vehicle.

All features cited in the above description and in the claims can be combined at random with the features of the independent claim. The disclosure of the invention is thus not limited to the described or claimed feature combinations, rather all feature combinations meaningful in terms of the invention are to be considered disclosed.

1. A method for wireless signal transmission from a sensor to a sensor-controlled component, wherein the sensor records a measuring signal,
wherein
the sensor utilises the energy recorded with the recorded measuring signal for operating an associated transmission unit, and in that the signal emitted by the transmission unit is determined by the amount of energy recorded with the measuring signal.

2. The method according to claim 1, wherein the energy recorded by the sensor with the measuring signal determines the signal strength of the emitted signal.

3. The method according to claim 1, wherein the energy recorded by the sensor with the measuring signal determines the frequency of the emitted signal.

4. The method according to claim 1, wherein the sensor receives light as a measuring signal and for energy intake.

5. The method according to claim 1, wherein the sensor uses the connected transmission unit to send a watchdog signal to the component.

6. A sensor-controlled component, with a sensor for detecting a physical variable for controlling the component and with a connection between the component and the sensor,
wherein
the connection between the component and the sensor is a wireless radio connection,
the sensor comprises a transmission unit,
the transmission unit is operated exclusively with energy recorded by the sensor, wherein the energy recorded by the sensor with the measuring signal determines a signal emitted by the transmission unit.

7. The sensor-controlled component according to claim 6, wherein the transmission unit is provided and designed for the purpose of emitting a signal with a signal strength, which corresponds to the energy recorded by the sensor with the measuring signal.

8. The component according to claim 6, wherein the transmission unit is provided and designed for the purpose of emitting a signal with a frequency, which corresponds to the energy recorded by the sensor with the measuring signal.

9. The component according to claim 6, wherein the sensor is a photovoltaic cell.

10. The component according to claim 6, wherein the sensor is completely without feed lines.

11. The component according to claim 6, wherein the component is a headlight system.

12. A sensor for a sensor-controlled component according to claim 6.
